(19) United States
(12) Patent Application Publication
(10) Pub. No.: US 2014/0349177 A1
(43) Pub. Date: Nov. 27, 2014

(54) MAGNESIUM HYBRID BATTERY AND ITS FABRICATION METHOD

(71) Applicant: KOREA INSTITUTE OF SCIENCE AND TECHNOLOGY, Seoul (KR)

(72) Inventors: Kyung Yoon CHUNG, Seoul (KR); Byung Won CHO, Seoul (KR); Joong Kee LEE, Seoul (KR); Hyung Sun KIM, Seoul (KR); Jae Hyun CHO, Seoul (KR); Won Young CHANG, Seoul (KR); Hwa Young LEE, Seoul (KR)

(73) Assignee: KOREA INSTITUTE OF SCIENCE AND TECHNOLOGY, Seoul (KR)

(21) Appl. No.: 14/016,549

(22) Filed: Sep. 3, 2013

(30) Foreign Application Priority Data
May 24, 2013 (KR) 10-2013-0059056

(51) Int. Cl. H01M 10/0568; H01M 10/058; H01M 4/58; H01M 10/054; H01M 10/052

(52) U.S. Cl. CPC H01M 10/0568; H01M 10/054; H01M 10/052; H01M 4/5815; H01M 10/058; H01M 2300/0025
USPC 429/200; 429/188; 429/199; 29/623.1

(57) ABSTRACT

The present disclosure relates to a magnesium hybrid battery and a method for fabricating same. The magnesium hybrid battery according to the present disclosure, which includes magnesium or magnesium alloy metal as an anode, a cathode including a cathode active material wherein not only magnesium ion but also one or more ion selected from lithium ion and sodium ion can be intercalated and deintercalated and an electrolyte including magnesium ion and further including one or more ion selected from lithium ion and sodium, can overcome the limitation of the existing magnesium secondary battery and provide improved battery capacity, output characteristics, cycle life, safety, etc.

### CROSS-REFERENCE TO RELATED APPLICATIONS

This application claims priority under 35 U.S.C. §119 to Korean Patent Application No. 10-2013-0059056 filed on May 24, 2013 in the Korean Intellectual Property Office, the disclosure of which is incorporated herein by reference in its entirety.

### TECHNICAL FIELD

The present disclosure relates to a magnesium hybrid battery and a method for fabricating same.

### BACKGROUND

A magnesium secondary battery is a secondary battery using magnesium which is a plentiful and inexpensive resource. With excellent safety and cost competitiveness, it is drawing a lot of attentions as a medium-to-large-sized battery for energy storage and electric vehicles whose markets are expected to expand greatly in the future. In spite of the very high theoretical energy density of the magnesium secondary battery, next to the lithium secondary battery, there has been no report on the magnesium battery for more than a decade since the first report in 1990 by T. Gregory, et al. Then, as reversibility is ensured with the development of Chevrel-phase cathode active material in the 2000s by the BIU group, the magnesium secondary battery has drawn attentions again as an alternative capable of solving the safety and cost problems of the lithium ion battery. However, since the energy density of the currently developed magnesium secondary battery is not more than half of the lithium ion battery, development of new cathode active materials, electrolyte solutions, current collectors, etc. is needed. At present, advancements are achieved mainly in cathode active materials and electrolyte solutions. With regard to the cathode active material, metal-sulfur compounds, organosulfur compounds, metal oxides, metal silicate compounds, etc. are studied to increase reversible capacity per unit weight and enhance reversibility, but no satisfactory result is achieved yet.

Recently, Chevrel-phase Mo₆S₈ was reported to show commercial applicability as a cathode active material. But, it is very inferior in terms of energy density, output characteristics, etc. as compared to the lithium ion battery. In particular, since intercalation and deintercalation of magnesium ions into the cathode active material are difficult and diffusion rate of magnesium ions is very low, development of a new cathode active material is very difficult. Accordingly, a new-concept secondary battery capable of solving these problems is necessary.

And, as for the electrolyte solution used for the magnesium secondary battery, Grignard solutions (RMgX, R=organic liquid, X=halide in ether solvents) that exhibit reversibility for the magnesium anode are extensively studied. Recently, it was reported that all-ethyl complex (AEC, EtMgCl-(EtAlCl₂)₂ complex) solutions and all-phenyl complex (APC, PhMgCl-AlCl₃ complex) solutions exhibit superior performance. However, since these electrolytes also show limit in cell performance due to low ionic conductivity and slow charge-discharge response, improvement is required to develop a magnesium secondary battery that can compete with the existing secondary battery.

### SUMMARY

The present disclosure is directed to providing a magnesium hybrid battery superior in performance to an existing secondary battery, which includes (1) an anode, (2) a cathode and (3) an electrolyte, wherein the anode is a magnesium metal, the cathode includes a cathode active material wherein one or more ion selected from magnesium ion, lithium ion and sodium ion can be intercalated and deintercalated, the electrolyte includes magnesium ion and the electrolyte further includes one or more ion selected from lithium ion and sodium ion, and a method for fabricating same.

In one general aspect, there is provided a magnesium hybrid battery including (1) an anode, (2) a cathode and (3) an electrolyte,

wherein

the anode is a magnesium or magnesium alloy metal;

the cathode includes a cathode active material wherein one or more ion selected from magnesium ion, lithium ion and sodium ion can be intercalated and deintercalated;

the electrolyte includes magnesium ion; and

the electrolyte further includes one or more ion selected from lithium ion and sodium ion.

In another general aspect, there is provided a method for fabricating a magnesium hybrid battery including (1) an anode, (2) a cathode and (3) an electrolyte, the method including:

(a) obtaining an assembled structure by assembling an anode and a cathode with a separator membrane therebetween; and

(b) injecting an electrolyte into the assembled structure;

wherein

the anode is magnesium or magnesium alloy metal foil;

the cathode includes a cathode active material wherein one or more ion selected from magnesium ion, lithium ion and sodium ion can be intercalated and deintercalated;

the electrolyte includes magnesium ion; and

the electrolyte further includes one or more ion selected from lithium ion and sodium ion.

Accordingly, the magnesium hybrid battery according to the present disclosure, which includes magnesium metal as an anode, a cathode including a cathode active material wherein not only magnesium ion but also one or more ion selected from lithium ion and sodium ion can be intercalated and deintercalated and an electrolyte including magnesium ion and further including one or more ion selected from lithium ion and sodium, can overcome the limitation of the existing magnesium secondary battery and provide improved battery capacity, output characteristics, cycle life, safety, etc.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 schematically illustrates a battery system designed according to the present disclosure;

FIG. 2 compares discharge characteristics of batteries Examples 1-4 and Comparative Example 1; and

FIG. 3 compares capacity and cycle life of batteries Examples 1-4 and Comparative Example 1.

### DETAILED DESCRIPTION OF EMBODIMENTS

Hereinafter, various aspects and exemplary embodiments of the present disclosure will be described in further detail.

In an aspect, the present disclosure provides a magnesium hybrid battery including (1) an anode, (2) a cathode and (3) an electrolyte,

wherein

the anode is a magnesium or magnesium alloy metal;

the cathode includes a cathode active material wherein one or more ion selected from magnesium ion, lithium ion and sodium ion can be intercalated and deintercalated;

the electrolyte includes magnesium ion; and

the electrolyte further includes one or more ion selected from lithium ion and sodium ion.

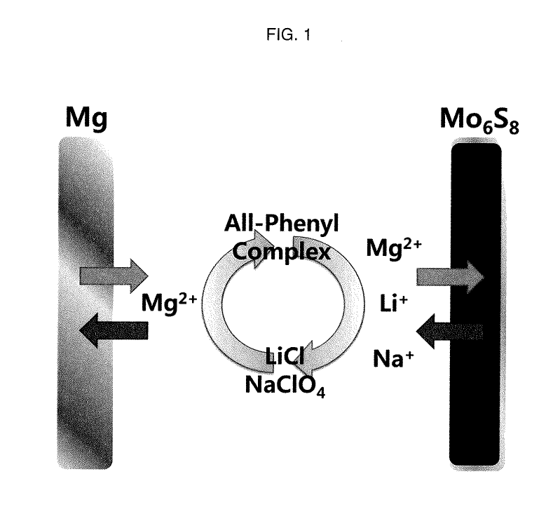

During discharging of the magnesium hybrid battery according to the present disclosure, dissolution, i.e. oxidation, of magnesium occurs at the anode and reduction of the cathode active material occurs at the cathode as the magnesium ion, the lithium ion, the sodium ion or a mixture thereof is intercalated into the cathode active material. Conversely, during charging, electrodeposition, i.e. reduction, of the magnesium ion to magnesium occurs at the anode and oxidation of the cathode active material occurs at the cathode as the magnesium ion, the lithium ion, the sodium ion or a mixture thereof is deintercalated from the cathode active material. The battery system (see FIG. 1) exhibits very superior stability.

In an exemplary embodiment of the present disclosure, the cathode active material is selected from Mo₆S₈, MoS₂, MgₓVPO₅F_{0.5}, Li₁₋ₐ₁FePO₄, Li₁₋ₐ₁FeₓMn_{y}PO₄, Li₃₋ₐ₃V₂(PO₄)₃, Li₁₋ₐ₁VPO₄F, Li₁₋ₐ₁CoO₂, Li₁₋ₐ₁Ni_{0.8}Co_{0.2}O₂, Li₁₋ₐ₁NiₓCo_{y}Mn_{z}O₂, Li₁₋ₐ₁Mn₂O₄, Li₁₋ₐ₁Ni_{0.5}Mn_{1.5}O₄, Li₂₋ₐ₂FeSiO₄, Li₂₋ₐ₂FeₓMn_{y}SiO₄, V₂O₅, S, Na_{2-b2}FePO₄F, Na_{2-b2}FeP₂O₇, Na_{1-b1}NiₓCo_{y}Mn_{z}O₂, Na_{1-b1}VPO₄F, Na_{1.5-b1.5}VOPO₄F_{0.5}, Na_{3-b3}V₂(PO₄)₃ and a mixture thereof,

wherein

a1 is a real number satisfying 0<a1<1;

a2 is a real number satisfying 0<a2<2;

a3 is a real number satisfying 0<a3<3;

b1 is a real number satisfying 0<b1<1;

b1.5 is a real number satisfying 0<b1.5<1.5;

b2 is a real number satisfying 0<b2<2;

b3 is a real number satisfying 0<b3<3;

x is a real number satisfying 0<x<1;

y is a real number satisfying 0<y<1; and

z is a real number satisfying 0<z<1.

The magnesium hybrid battery according to the present disclosure, which not includes only the magnesium ion as the cathode active material but also further includes one or more ion selected from the lithium ion and the sodium ion, solves the problem of the existing magnesium battery of difficulty in intercalation and deintercalation of the magnesium ion into and from the cathode active material and very low diffusion rate of the magnesium ion in the cathode active material and provides very superior output characteristics. Accordingly, it can be usefully used as a secondary battery replacing the existing magnesium secondary battery.

In another exemplary embodiment of the present disclosure, the magnesium ion included in the electrolyte is dissociated from one or more magnesium compound selected from ethylmagnesium bromide (EtMgBr), ethylmagnesium chloride (EtMgCl), all-ethyl complex (AEC, EtMgCl-(EtAlCl₂)₂ complex), all-phenyl complex (APC, PhMgCl-AlCl₃ complex), Mg(ClO₄)₂, Mg(TFSI)₂ and a mixture thereof.

In another exemplary embodiment of the present disclosure, the electrolyte further includes lithium ion dissociated from one or more lithium compound selected from LiCl, LiClO₄ and Li(TFSI) or sodium ion dissociated from one or more sodium compound selected from NaCl, NaClO₄ and Na(TFSI).

The magnesium hybrid battery according to the present disclosure, which uses an organic solvent electrolyte including the magnesium ion and further including one or more ion selected from the lithium ion and the sodium ion as the electrolyte, solves the problem of the existing magnesium secondary battery of low ionic conductivity and slow charge-discharge response, which lead to deteriorated cell performance, and provides greatly improved discharge capacity and cycle life. Accordingly, it can be usefully used as a secondary battery replacing the existing magnesium secondary battery. In particular, a combined use of the magnesium ion, the lithium ion and the sodium ion provides the advantage of solving the problem of the existing magnesium secondary battery that superior charge-discharge characteristics are not obtained because of limitation of the cathode active materials into and from which the magnesium ion can be intercalated and deintercalated and low diffusion rate of the magnesium ion in the active material. That is to say, the combined use of the ions allows use of various cathode active materials into and from which not only the magnesium ion but also the lithium ion and the sodium ion can be intercalated and deintercalated, thereby improving energy density through enhanced battery voltage and discharge capacity and improving charge-discharge characteristics. Meanwhile, the existing lithium secondary battery and sodium secondary battery have the problem that, when lithium metal and sodium metal are used as the anode, dendrites of lithium and sodium are formed upon overcharging or if the potential distribution in the electrode is non-uniform, leading to safety and cycle life problems. Also, if lithium metal and sodium metal are exposed to the atmosphere as a result of damage to the battery, they may react with moisture and oxygen, thus leading to explosion, fire or other safety problems. In contrast, the magnesium hybrid battery of the present disclosure can avoid the formation of dendrites during charging since the magnesium anode is used and, thus, safety and cycle life are improved. In addition, since the magnesium metal is stable in the atmosphere, explosion, fire or other safety problems can be avoided when the battery is damaged.

In another aspect, the present disclosure provides a method for fabricating a magnesium hybrid battery including (1) an anode, (2) a cathode and (3) an electrolyte, the method including:

(a) obtaining an assembled structure by assembling an anode and a cathode with a separator membrane therebetween; and

(b) injecting an electrolyte into the assembled structure;

wherein

the anode is magnesium or magnesium alloy metal foil; the cathode includes a cathode active material wherein one or more ion selected from magnesium ion, lithium ion and sodium ion can be intercalated and deintercalated;

the electrolyte includes magnesium ion; and

the electrolyte further includes one or more ion selected from lithium ion and sodium ion.

In an exemplary embodiment of the present disclosure, in the method for fabricating a magnesium hybrid battery, the cathode active material is selected from Mo₆S₈, MOS₂, MgₓVPO₅F_{0.5}, Li₁₋ₐ₁FePO₄, Li₁₋ₐ₁FeₓMn_{y}PO₄, Li₃₋ₐ₃V₂(PO₄)₃, Li₁₋ₐ₁VPO₄F, Li₁₋ₐ₁CoO₂, Li₁₋ₐ₁Ni_{0.8}Co_{0.20}O₂, Li₁₋ₐ₁NiₓCo_{y}Mn_{z}O₂, Li₁₋ₐ₁Mn₂O₄, Li₁₋ₐ₁Ni_{0.5}Mn_{1.5}O₄, Li₂₋ₐ₂FeSiO₄, Li₂₋ₐ₂FeₓMn_{y}SiO₄, V₂O₅, S, Na_{2-b2}FePO₄F, Na_{2-b2}FeP₂O₇, Na_{1-b1}NiₓCo_{y}Mn_{z}O₂, Na_{1-b1}VPO₄F, Na_{1.5-b1.5}VOPO₄F_{0.5}, Na_{3-b3}V₂(PO₄)₃ and a mixture thereof,

wherein

a1 is a real number satisfying 0<a1<1;

a2 is a real number satisfying 0<a2<2;

a3 is a real number satisfying 0<a3<3;

b1 is a real number satisfying 0<b1<1;

b1.5 is a real number satisfying 0<b1.5<1.5;

b2 is a real number satisfying 0<b2<2;

b3 is a real number satisfying 0<b3<3;

x is a real number satisfying 0<x<1;

y is a real number satisfying 0<y<1; and

z is a real number satisfying 0<z<1.

In another exemplary embodiment of the present disclosure, the magnesium ion included in the electrolyte is dissociated from one or more magnesium compound selected from ethylmagnesium bromide (EtMgBr), ethylmagnesium chloride (EtMgCl), all-ethyl complex (AEC, EtMgCl-(EtAlCl₂)₂ complex), all-phenyl complex (APC, PhMgCl-AlCl₃ complex), Mg(ClO₄)₂, Mg(TFSI)₂ and a mixture thereof.

In another exemplary embodiment of the present disclosure, the electrolyte further includes lithium ion dissociated from one or more lithium compound selected from LiCl, LiClO₄ and Li(TFSI) or sodium ion dissociated from one or more sodium compound selected from NaCl, NaClO₄ and Na(TFSI).

In another exemplary embodiment of the present disclosure, an organic solvent used to dissolve the magnesium ion, the lithium ion and the sodium ion, which may be identical or different, is independently one or more selected from tetrahydrofuran (THF), dimethoxyethane (DME), diglyme, triglyme, tetraglyme, acetonitrile and an ionic liquid.

In another exemplary embodiment of the present disclosure, the ionic liquid includes one or more cation selected from pyrrolidinium, imidazolium, piperidinium, pyridinium, ammonium and morpholinium.

According to the embodiments of the present disclosure, the magnesium hybrid battery of the present disclosure, which includes magnesium or magnesium alloy metal as an anode, a cathode including a cathode active material wherein not only magnesium ion but also one or more ion selected from lithium ion and sodium ion can be intercalated and deintercalated and an electrolyte including magnesium ion and further including one or more ion selected from lithium ion and sodium, can overcome the limitation of the existing magnesium secondary battery and provide improved battery capacity, output characteristics, cycle life, safety, etc.

### EXAMPLES

Hereinafter, the present disclosure will be described in more detail through examples. However, the following examples are for illustrative purposes only and not intended to limit the scope of this disclosure.

### Example 1

200-μm thick magnesium foil was used as an anode and a cathode was prepared by applying a 90:5:5 mixture of Mo₆S₈ cathode active material, Denka black as a conducting material and PVdF binder (solution in NMP) onto a nickel foil current collector followed by drying and press rolling. An electrolyte solution for a magnesium hybrid battery was prepared by dissolving 0.0025 mol of LiCl in a solution of 0.04 mol of all-phenyl complex (APC, PhMgCl-AlCl₃ complex) electrolyte salt in 100 mL of THF solvent. A magnesium hybrid battery coin cell was constructed using the magnesium foil anode, the Mo₆S₈ cathode, a PP separator membrane and the electrolyte solution and battery capacity and cycle life were tested under a charge-discharge voltage of 0.4-2.0 V.

### Example 2

A magnesium foil anode and a Mo₆S₈ cathode were prepared in the same manner as in Example 1. An electrolyte solution for a magnesium hybrid battery was prepared by dissolving 0.005 mol of LiCl in a solution of 0.04 mol of all-phenyl complex (APC, PhMgCl-AlCl₃ complex) electrolyte salt in 100 mL of THF solvent. A magnesium hybrid battery coin cell was constructed using the magnesium foil anode, the Mo₆S₈ cathode, a PP separator membrane and the electrolyte solution and battery capacity and cycle life were tested under a charge-discharge voltage of 0.4-2.0 V.

### Example 3

A magnesium foil anode and a Mo₆S₈ cathode were prepared in the same manner as in Example 1. An electrolyte solution for a magnesium hybrid battery was prepared by dissolving 0.01 mol of NaClO₄ in a solution of 0.025 mol of all-phenyl complex (APC, PhMgCl-AlCl₃ complex) electrolyte salt in 100 mL of THF solvent. A magnesium hybrid battery coin cell was constructed using the magnesium foil anode, the Mo₆S₈ cathode, a PP separator membrane and the electrolyte solution and battery capacity and cycle life were tested under a charge-discharge voltage of 0.4-2.0 V.

### Example 4

A magnesium foil anode and a Mo₆S₈ cathode were prepared in the same manner as in Example 1. An electrolyte solution for a magnesium hybrid battery was prepared by dissolving 0.05 mol of LiCl in a solution of 0.025 mol of all-phenyl complex (APC, PhMgCl-AlCl₃ complex) electrolyte salt in 100 mL of THF solvent. A magnesium hybrid battery coin cell was constructed using the magnesium foil anode, the Mo₆S₈ cathode, a PP separator membrane and the electrolyte solution and battery capacity and cycle life were tested under a charge-discharge voltage of 0.4-2.0 V.

### Comparative Example 1

0.04 mol of all-phenyl complex (APC, PhMgCl-AlCl₃ complex) electrolyte salt was dissolved in 100 mL of THF solvent. The resulting 0.4 M APC solution was used as an electrolyte solution. A magnesium hybrid battery coin cell was constructed using a magnesium foil anode, an Mo₆S₈ cathode, a PP separator membrane and the electrolyte solution in the same manner as in Example 1 and battery capacity and cycle life were tested under a charge-discharge voltage of 0.4-1.8 V.

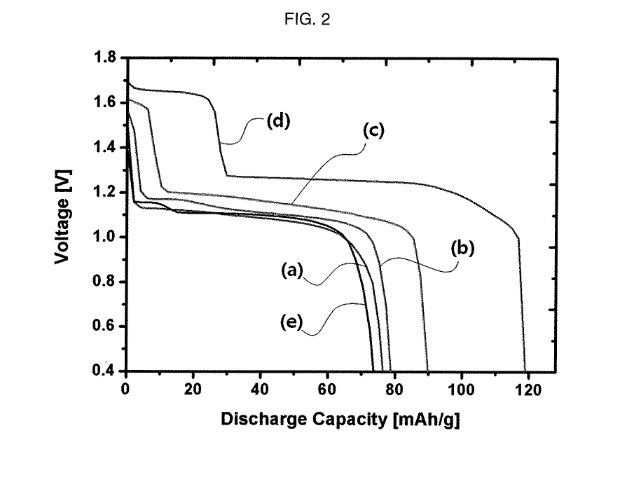

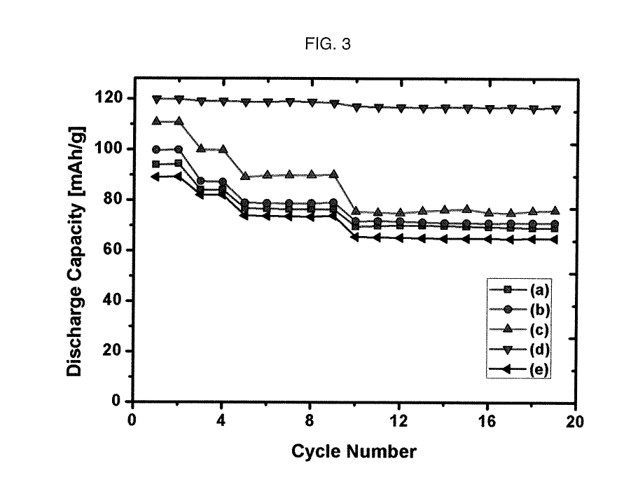

As seen from FIG. 2, the batteries of Examples 1-4 according to the present disclosure exhibit higher discharge voltage and discharge capacity than that of Comparative Example 1. Also, as seen from FIG. 3, the batteries of Examples 1-4 according to the present disclosure exhibit better discharge capacity and cycle life than that of Comparative Example 1. In particular, the battery of Example 4 shows no change in discharge capacity in spite of increased cycle number.

Accordingly, the magnesium hybrid battery according to the present disclosure, which includes magnesium metal as an anode, a cathode including a cathode active material wherein not only magnesium ion but also one or more ion selected from lithium ion and sodium ion can be intercalated and deintercalated and an electrolyte including magnesium ion and further including one or more ion selected from lithium ion and sodium, can overcome the limitation of the existing magnesium secondary battery and provide improved battery capacity, output characteristics, cycle life, safety, etc.

While the present disclosure has been described with respect to the specific embodiments, it will be apparent to those skilled in the art that various changes and modifications may be made without departing from the spirit and scope of the disclosure as defined in the following claims.

What is claimed is:

1. A magnesium hybrid battery comprising (1) an anode, (2) a cathode and (3) an electrolyte,
wherein
the anode is a magnesium or magnesium alloy metal;
the cathode comprises a cathode active material wherein one or more ion selected from magnesium ion, lithium ion and sodium ion can be intercalated and deintercalated;
the electrolyte comprises magnesium ion; and
the electrolyte further comprises one or more ion selected from lithium ion and sodium ion.

2. The magnesium hybrid battery according to claim 1, wherein the cathode active material is one or more material selected from Mo₆S₈, MoS₂, MgₓVPO₅F_{0.5}, Li₁₋ₐ₁FePO₄, Li₁₋ₐ₁FeₓMn_{y}PO₄, Li₃₋ₐ₃V₂(PO₄)₃, Li₁₋ₐ₁VPO₄F, Li₁₋ₐ₁CoO₂, Li₁₋ₐ₁Ni_{0.8}Co_{0.2}O₂, Li₁₋ₐ₁NiₓCo_{y}Mn_{z}O₂, Li₁₋ₐ₁Mn₂O₄, Li₁₋ₐ₁Ni_{0.5}Mn_{1.5}O₄, Li₂₋ₐ₂FeSiO₄, Li₂₋ₐ₂FeₓMn_{y}SiO₄, V₂O₅, S, Na_{2-b2}FePO₄F, Na_{2-b2}FeP₂O₇, Na_{1-b1}NiₓCo_{y}Mn_{z}O₂, Na_{1-b1}VPO₄F, Na_{1.5-b1.5}VOPO₄F_{0.5} and Na_{3-b3}V₂(PO₄)₃,
wherein
a1 is a real number satisfying 0<a1<1;
a2 is a real number satisfying 0<a2<2;
a3 is a real number satisfying 0<a3<3;
b1 is a real number satisfying 0<b1<1;
b1.5 is a real number satisfying 0<b1.5<1.5;
b2 is a real number satisfying 0<b2<2;
b3 is a real number satisfying 0<b3<3;
x is a real number satisfying 0<x<1;
y is a real number satisfying 0<y<1; and
z is a real number satisfying 0<z<1.

3. The magnesium hybrid battery according to claim 1,
wherein
the magnesium ion included in the electrolyte is dissociated from one or more magnesium compound selected from ethylmagnesium bromide (EtMgBr), ethylmagnesium chloride (EtMgCl), all-ethyl complex (AEC, EtMgCl-(EtAlCl₂)₂ complex), all-phenyl complex (APC, PhMgCl-AlCl₃ complex), Mg(ClO₄)₂ and Mg(TFSI)₂;
the lithium ion included in the electrolyte is dissociated from one or more lithium compound selected from LiCl, LiClO₄ and Li(TFSI); and
the sodium ion included in the electrolyte is dissociated from one or more sodium compound selected from NaCl, NaClO₄ and Na(TFSI).

4. A method for fabricating a magnesium hybrid battery comprising (1) an anode, (2) a cathode and (3) an electrolyte, the method comprising:
(a) obtaining an assembled structure by assembling an anode and a cathode with a separator membrane therebetween; and
(b) injecting an electrolyte into the assembled structure;
wherein
the anode comprises magnesium or magnesium alloy metal foil;
the cathode comprises a cathode active material wherein one or more ion selected from magnesium ion, lithium ion and sodium ion can be intercalated and deintercalated;
the electrolyte comprises magnesium ion; and
the electrolyte further comprises one or more ion selected from lithium ion and sodium ion.

5. The method for fabricating a magnesium hybrid battery according to claim 4, wherein the cathode active material is one or more material selected from Mo₆S₈, MoS₂, MgₓVPO₅F_{0.5}, Li₁₋ₐ₁FePO₄, Li₁₋ₐ₁FeₓMn_{y}PO₄, Li₃₋ₐ₃V₂(PO₄)₃, Li₁₋ₐ₁VPO₄F, Li₁₋ₐ₁CoO₂, Li₁₋ₐ₁Ni_{0.8}Co_{0.2}O₂, Li₁₋ₐ₁NiₓCo_{y}Mn_{z}O₂, Li₁₋ₐ₁Mn₂O₄, Li₁₋ₐ₁Ni_{0.5}Mn_{1.5}O₄, Li₂₋ₐ₂FeSiO₄, Li₂₋ₐ₂FeₓMn_{y}SiO₄, V₂O₅, S, Na_{2-b2}FePO₄F, Na_{2-b2}FeP₂O₇, Na_{1-b1}NiₓCo_{y}Mn_{z}O₂, Na_{1-b1}VPO₄F, Na_{1.5-b1.5}VOPO₄F_{0.5} and Na_{3-b3}V₂(PO₄)₃,
wherein
a1 is a real number satisfying 0<a1<1;
a2 is a real number satisfying 0<a2<2;
a3 is a real number satisfying 0<a3<3;
b1 is a real number satisfying 0<b1<1;
b1.5 is a real number satisfying 0<b1.5<1.5;
b2 is a real number satisfying 0<b2<2;
b3 is a real number satisfying 0<b3<3;
x is a real number satisfying 0<x<1;
y is a real number satisfying 0<y<1; and
z is a real number satisfying 0<z<1.

6. The method for fabricating a magnesium hybrid battery according to claim 4,
wherein
the magnesium ion included in the electrolyte is dissociated from one or more magnesium compound selected from ethylmagnesium bromide (EtMgBr), ethylmagnesium chloride (EtMgCl), all-ethyl complex (AEC, EtMgCl-(EtAlCl₂)₂ complex), all-phenyl complex (APC, PhMgCl-AlCl₃ complex), Mg(ClO₄)₂ and Mg(TFSI)₂;
the lithium ion included in the electrolyte is dissociated from one or more lithium compound selected from LiCl, LiClO₄ and Li(TFSI); and
the sodium ion included in the electrolyte is dissociated from one or more sodium compound selected from NaCl, NaClO₄ and Na(TFSI).

7. The method for fabricating a magnesium hybrid battery according to claim 4, wherein an organic solvent used to dissolve the magnesium ion, the lithium ion and the sodium ion, which may be identical or different, is independently one or more selected from tetrahydrofuran (THF), dimethoxyethane (DME), diglyme, triglyme, tetraglyme, acetonitrile and an ionic liquid.

8. The method for fabricating a magnesium hybrid battery according to claim 7, wherein the ionic liquid comprises one or more cation selected from pyrrolidinium, imidazolium, piperidinium, pyridinium, ammonium and morpholinium.
